(19) United States
(12) Patent Application Publication
(10) Pub. No.: US 2009/0161703 A1
(43) Pub. Date: Jun. 25, 2009

(54) SUM-FREQUENCY-MIXING Pr:YLF LASER APPARATUS WITH DEEP-UV OUTPUT

(76) Inventors: Wolf Seelert, Lubeck (DE); Norman Hodgson, Belmont, CA (US); Andreas Diening, Palo Alto, CA (US)

Correspondence Address: STALLMAN & POLLOCK LLP, P.O. Box 26450, SAN FRANCISCO, CA, 94126, US

(21) Appl. No.: 11/961,162

(22) Filed: Dec. 20, 2007

(51) Int. Cl. H01S 3/10

(52) U.S. Cl. 372/22

(57) ABSTRACT

A method for generating ultraviolet radiation includes sum-frequency mixing in one optically nonlinear crystal fundamental-wavelength radiation generated by a Pr:YLF gain-element with radiation having a second-harmonic wavelength of fundamental-wavelength radiation generated by a Pr:YLF gain-element. The second-harmonic wavelength is generated in another optically nonlinear crystal. The fundamental-wavelength radiation being mixed and the fundamental wavelength radiation from which the second-harmonic radiation is generated may have the same wavelength or different wavelengths.

### TECHNICAL FIELD OF THE INVENTION

The present invention relates in general to intracavity frequency-converted lasers. The invention relates in particular to intracavity frequency converted solid-state lasers providing output radiation having a deep UV wavelength.

### DISCUSSION OF BACKGROUND ART

CW and quasi CW lasers having output in the deep ultraviolet (UV) region of the spectrum are preferred light-sources for inspection of semiconductor devices. The terminology “deep UV”, here, refers to radiation having a wavelength of about 200 nm or less. Lasers currently in commercial use for such inspection include all-solid-state lasers having a gain-medium of neodymium-doped YAG (Nd:YAG) or neodymium doped yttrium vanadate (Nd:YVO₄). These gain-media can efficiently generate fundamental radiation at a wavelength of about 1064 nm, which must be converted by frequency multiplication and sum-frequency mixing stages in optically nonlinear crystals to provide deep UV output. At least three such stages are required depending on the output wavelength desired

Generally, the more harmonic-conversion or frequency-mixing stages that are required in a laser the less efficient the laser will be. There is no prospect, at present, of discovering a gain-medium that would be able to generate deep-UV CW radiation as a fundamental wavelength, thereby avoiding a need for frequency conversion. It would be advantageous, however, to have an all-solid-state laser in which deep-UV CW radiation could be generated in less than three frequency conversion stages.

### SUMMARY OF THE INVENTION

The present invention is directed to a method and apparatus for generating ultraviolet radiation by two stages of wavelength conversion. In one aspect a method of generating ultraviolet radiation comprises the step sum-frequency mixing in a first optically nonlinear crystal fundamental-wavelength radiation generated by a Pr:YLF gain-element having a laser-transition wavelength of Pr:YLF about equal to or less than 720 nm with radiation having a second-harmonic wavelength of fundamental-wavelength radiation generated by a Pr:YLF gain-element. The second-harmonic wavelength is generated in a second optically nonlinear crystal and has a wavelength of about 360 nm or less.

The wavelength of the fundamental-wavelength radiation being mixed and the wavelength of the fundamental wavelength from which the second-harmonic radiation is generated may be the same or different.

A preferred embodiment of apparatus in accordance with the present invention includes a first laser-resonator including a Pr:YLF gain-element in which the fundamental wavelength being mixed is generated and in which the first optically nonlinear crystal is located. The second-harmonic radiation is generated by a second laser-resonator including a Pr:YLF gain-element and the second optically nonlinear crystal. Second-harmonic wavelength radiation from the second laser-resonator is directed into the first optically nonlinear crystal for sum-frequency mixing with the fundamental radiation generated in the first laser-resonator.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of apparatus in accordance with the present invention including a first laser-resonator including a Pr:YLF gain-element generating fundamental-wavelength radiation at a wavelength of 522 nm and a first optically nonlinear crystal arranged to convert the fundamental-wavelength radiation to second-harmonic radiation having a wavelength of 261 nm, and a second laser-resonator including a Pr:YLF gain-element generating fundamental wavelength-radiation at a wavelength of 720 nm and a second optically nonlinear crystal arranged to sum-frequency mix the 720 nm fundamental radiation with 261 nm radiation delivered from the first laser-resonator thereby generating UV radiation having a wavelength of 191.6 nm.

FIG. 2 schematically illustrates another preferred embodiment of apparatus in accordance with the present invention including laser-resonator including a Pr:YLF gain-element arranged to generate fundamental wavelength radiation having a wavelength of 590 nm, a first optically nonlinear crystal arranged to convert the fundamental-wavelength radiation to second-harmonic radiation having a wavelength of 295 nm, and a second optically nonlinear crystal arranged to sum-frequency mix the fundamental-wavelength and the second-harmonic radiation to provide third-harmonic radiation having a wavelength of 196.7 nm.

FIG. 3 schematically illustrates yet another preferred embodiment of apparatus in accordance with the present invention including laser-resonator including a Pr:YLF gain-element arranged to generate fundamental wavelength radiation having a wavelength of 607 nm, a first optically nonlinear crystal located outside the laser-resonator and arranged to convert the fundamental-wavelength radiation delivered into second-harmonic radiation having a wavelength of 303.5 nm, and a second optically nonlinear crystal located outside of the laser-resonator and arranged to sum-frequency mix fundamental-wavelength radiation residual from the second-harmonic generation with the second-harmonic radiation to provide third-harmonic radiation having a wavelength of 202.3 nm.

### DETAILED DESCRIPTION OF THE INVENTION

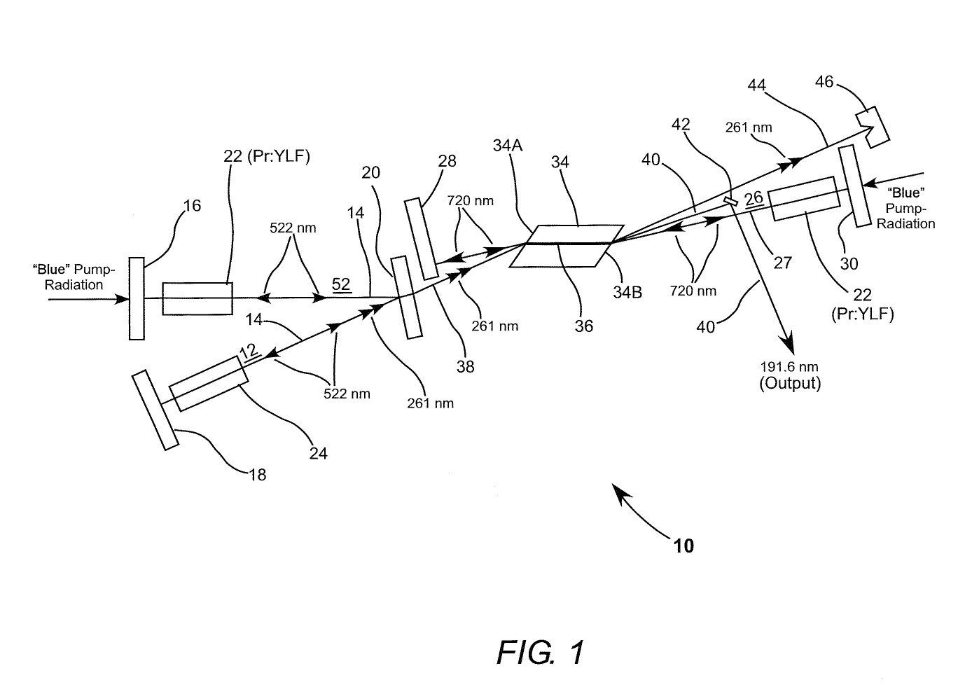

Referring now to the drawings, wherein like components are designated by like reference numerals, FIG. 1 schematically illustrates one preferred embodiment 10 of laser apparatus in accordance with the present invention. Apparatus 10 includes a first laser-resonator 12 having a resonator axis 14. Resonator 12 is terminated by mirrors 16 and 18 and “folded” by a dichroic mirror 20. Resonator 12 includes a gain-element 22 of praseodymium doped yttrium lithium fluoride (Pr:YLF). The gain-element is optically pumped by radiation (“blue light”) having a wavelength less than 500 nm corresponding to an absorption line of the Pr:YLF. Preferred pump-radiation wavelengths are between about 440 nm and about 470 nm. The pump-light radiation can be supplied by one or more indium gallium nitride (InGaN) diode-lasers or by a frequency-doubled, optically-pumped semiconductor (OPS) laser.

Pr:YLF has strong laser transitions (gain-lines) at wavelengths of about 522 nm, about 545 nm, about 590 nm, about 607 nm, about 639 nm, about 697 nm, and about 720 nm. These transitions have second-harmonic wavelengths of about 261 nm, about 277.5 nm, about 295 nm, about 303.5 nm, about 319.5 nm, about 348.5 nm, and about 360 nm respectively. A detailed description of Pr:YLF gain-lines, second-harmonics thereof, and optical pumping arrangements for resonators including a Pr:YLF gain-medium is provided in U.S. Pre-Grant Publication No. 2007/0177638, assigned to the assignee of the present invention, and the complete disclosure of which is hereby incorporated by reference. Selection of a particular one of the gain-wavelengths for oscillation in a resonator can be accomplished by providing a wavelength-selective reflective coating on one or more resonator mirrors, or by including a wavelength-selective transmissive element, such as a birefringent filter or an etalon, in the resonator, as is known in the art.

In this example of apparatus 10, resonator 12 is arranged to generate fundamental radiation at a wavelength of 522 nm. An optically nonlinear crystal 24 is arranged to convert circulating fundamental-wavelength radiation into second-harmonic (2H) radiation having a wavelength of 261 nm and designated by double arrow heads. Fold mirror 20 is made transparent to the 261 nm radiation which leaves resonator 12 along a path 38.

Apparatus 10 includes a second laser-resonator 26 having a resonator axis 27. Resonator 26 is a straight resonator terminated by mirrors 28 and 30. Resonator 26 includes a Pr:YLF gain-element 22 and, in this example of apparatus 10, is arranged to generate fundamental radiation at a wavelength of about 720 nm in response to being pumped by light transmitted through mirror 30. An optically nonlinear crystal 34 is located in resonator 26. Crystal 34 has faces 34A and 34B cut at the Brewster angle for circulating fundamental-wavelength radiation, and is arranged for sum-frequency mixing the 720-nm fundamental wavelength radiation with 261 nm radiation delivered from resonator 10 along path 38. The sum-frequency mixing generates deep-UV radiation having a wavelength of about 191.6 nm. Suitable materials for optically nonlinear crystals 24 and 34 include β-barium borate (BBO) and cesium lithium borate (CLBO). The present invention is not limited, however, to the use of any particular optically nonlinear crystal.

Continuing with reference to FIG. 1, path 38 is incident on face 34A of crystal 34 at the Brewster angle for 261 nm radiation which provides that the 720 nm fundamental radiation of resonator 26 and the 261 nm 2H-radiation from resonator 10 propagate collinearly along longitudinal axis 36 of optically nonlinear crystal 34. Residual 262-nm radiation exits crystal 34 via face 34A thereof along a path 44 and is absorbed in a beam-dump 46. The 191.6 nm radiation generated by the sum-frequency mixing exits face 34B of crystal 34 along a path 40 at an angle to both the 720 nm fundamental radiation and the 261 nm radiation. Path 40 is intercepted by a pick-off mirror 42 and directed away from resonator 26 as output radiation.

Apparatus 10 is useful when the second-harmonic radiation of a first fundamental wavelength of Pr:YLF is mixed with radiation at a second, different, fundamental wavelength of Pr:YLF. Clearly, however, the fundamental wavelength in resonators 12 and 26 can be selected to the same such that third-harmonic (3H) radiation of this fundamental wavelength is generated in optically nonlinear crystal 34.

Third harmonic radiation can also be generated using only two conversion stages, either inside or outside of a resonator including a Pr:YLF gain-element.

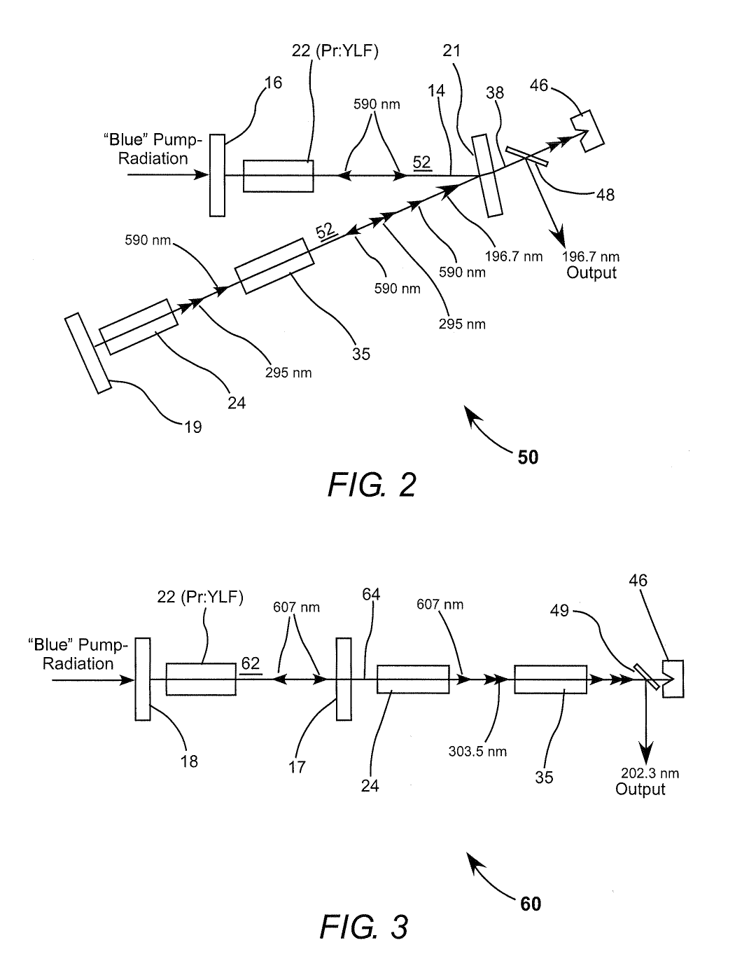

By way of example, FIG. 2 schematically illustrates another preferred embodiment 50 of apparatus in accordance with the present invention. Apparatus 50 includes a laser-resonator 52 terminated by mirrors 16 and 19 and folded by a dichroic mirror 21. In this example of apparatus 50, resonator 52 includes a Pr:YLF gain-element 22 and is arranged to generate fundamental radiation at a wavelength of 590 nm. Resonator 52 includes an optically nonlinear crystal 24 arranged to generate 2H-radiation having a wavelength of 295 nm and an optically nonlinear crystal 35 arranged to generate 3H-radiation having a wavelength of about 196.7 nm by sum-frequency mixing the fundamental-wavelength radiation with the 2H-radiation. Fold mirror 21 is transparent to the 2H-radiation and the 3H-radiation, which exit the resonator via mirror 21 along path 39. A pick off mirror 48 reflects the 196.7 nm (3H) radiation away from the resonator as output radiation and transmits the 211 radiation to a beam-dump 46.

FIG. 3 schematically illustrates yet another embodiment 60 of apparatus in accordance with the present invention. Apparatus 60 includes a straight laser-resonator 62 terminated by mirrors 18 and 17. Resonator 62 includes a Pr:YLF gain-element 22 and is arranged to generate fundamental radiation at a wavelength of about 607 nm. Mirror 17 is partially transparent to the fundamental-wavelength radiation and couples a portion of the circulating fundamental-wavelength radiation out of the laser-resonator along path 64. Located in path 64 are optically nonlinear crystals 24 and 35. Crystal 24 is arranged to generate 2H-radiation having a wavelength of about 303.5 nm and optically nonlinear crystal 35 is arranged to generate 3H-radiation having a wavelength of about 202.3 nm by sum-frequency mixing the fundamental-wavelength radiation with the 2H-radiation. A pick off mirror 49 reflects the 202.3 nm (3H) radiation away from the propagation axis as output radiation of the apparatus and transmits residual 2H-radiation to a beam-dump 46.

It should be noted here that while generating third-harmonic radiation of a Pr:YLF laser transition wavelength is described above with reference to apparatus 50 and 60 of FIGS. 2 and 3, 3H radiation can also be generated in apparatus 10 of FIG. 1 by arranging resonators 12 and 26 thereof to generate the same fundamental-wavelength. While the present invention is described above in terms of a preferred and other embodiments the invention is not limited to the embodiments described and depicted. Rather, the invention is limited only by the claims appended hereto.

What is claimed is:

1. A method of generating ultraviolet radiation, comprising the step of:
sum-frequency mixing in a first optically nonlinear crystal fundamental-wavelength radiation generated by a Pr:YLF gain-element having a laser-transition wavelength of Pr:YLF about equal to or less than 720 nm with radiation having a second-harmonic wavelength of fundamental-wavelength radiation generated by a Pr:YLF gain-element, the second-harmonic wavelength being generated in a second optically nonlinear crystal and having a wavelength of about 360 nm or less.

2. The method of claim 1, wherein the fundamental-wavelength being sum-frequency mixed and the fundamental wavelength from which the second-harmonic radiation are the same.

3. The method of claim 1, wherein the fundamental-wavelength being sum-frequency mixed and the fundamental wavelength from which the second-harmonic radiation are different.

4. The method of claim 1, wherein the fundamental-wavelength radiation being sum-frequency mixed is one of about 522 nm, about 545 nm, about 590 nm, about 607 nm, about 639 nm, about 697 nm, and about 720 nm and the second-harmonic radiation being sum-frequency mixed is one of about 261 nm, about 277.5 nm, about 295 nm, about 303.5 nm, about 319.5 nm, about 348.5 nm, and about 360 nm.

5. The method of claim 1, wherein the fundamental-wavelength being mixed is generated in a first laser-resonator including a first Pr:YLF gain-element and the first optically nonlinear crystal, the second-harmonic wavelength radiation being mixed is generated in a second laser-resonator including a second Pr:YLF-gain-element and the second optically nonlinear crystal, and the second-harmonic radiation is delivered from the second laser-resonator to the first optically nonlinear crystal for the sum-frequency mixing.

6. A method of generating ultraviolet radiation, comprising the step of:
in a first laser-resonator including a Pr:YLF gain element and a first optically nonlinear crystal generating fundamental radiation having a wavelength which is one of about 522 nm, about 545 nm, about 590 nm, about 607 nm, about 639 nm, about 697 nm, and about 720 nm;
in a second laser-resonator including a Pr:YLF gain-element and a second optically nonlinear crystal generating fundamental radiation having a wavelength which is one of about 522 nm, about 545 nm, about 590 nm, about 607 nm, about 639 nm, about 697 nm, and about 720 nm;
converting the fundamental radiation generated in the second laser-resonator into second harmonic radiation having a wavelength which is one-half of the fundamental wavelength;
delivering the second-harmonic radiation from the second laser-resonator to the first optically nonlinear crystal; and
in the first optically nonlinear crystal, sum-frequency mixing the second harmonic radiation from the second laser-resonator with fundamental-wavelength radiation generated in the first laser-resonator to thereby generating frequency-converted radiation having a wavelength in the deep ultraviolet.

7. The method of claim 6, wherein the fundamental radiation generated in the first laser-resonator and the fundamental radiation generated in the second laser-resonator have the same wavelength.

8. The method of claim 6, wherein the fundamental radiation generated in the first laser-resonator has a wavelength different from the wavelength of the fundamental radiation generated in the second laser-resonator.

9. The method of claim 8, wherein the fundamental radiation generated in the first laser-resonator has a wavelength of about 720 nm, the second harmonic radiation delivered from the second laser-resonator has a wavelength of about 261 nm, and the frequency-converted radiation generated in the first optically nonlinear crystal has a wavelength of about 191.6 nm.

10. An apparatus for generating ultraviolet radiation comprising:
a first laser resonator including a first Pr:YLF gain element and a first optically nonlinear crystal generating a frequency doubled output; and
a second laser resonator including a second Pr:YLF gain-element and a second optically nonlinear crystal, wherein the frequency doubled output from the first laser resonator and the fundamental radiation generated in the second laser resonator by the second PR:YLF gain element are sum frequency mixed within the second optically nonlinear crystal to generate frequency-converted radiation having a wavelength in the deep ultraviolet.
